(19) United States
(12) Patent Application Publication
(10) Pub. No.: US 2010/0178572 A1
(43) Pub. Date: Jul. 15, 2010

(54) ELECTRON TRANSFER MEDIATOR MODIFIED ENZYME ELECTRODE AND BIOFUEL CELL COMPRISING THE SAME

(75) Inventors: Hisao Kato, Brussels (BE); Hidetaka Nishikoori, Susono-shi Shizuoka-ken (JP); Kenji Kano, Kashihara-shi, Nara-ken (JP); Seiya Tsujimura, Kashihara-shi, Nara-ken (JP)

Correspondence Address: GIFFORD, KRASS, SPRINKLE,ANDERSON & CITKOWSKI, P.C, PO BOX 7021, TROY, MI, 48007-7021, US

(73) Assignee: TOYOTA JIDOSHA KABUSHIKI KAISHA, Aichi-Ken (JP)

(21) Appl. No.: 12/440,526

(22) PCT Filed: Sep. 13, 2007
(86) PCT No.: PCT/JP2007/068474

§ 371 Date: Apr. 22, 2009

(30) Foreign Application Priority Data
Sep. 13, 2006 (JP) JP2006-248206

(51) Int. Cl. H01M 8/16

(52) U.S. Cl. 429/401

(57) ABSTRACT

The present invention provides an electron transfer mediator modified enzyme electrode which can obtain a high current density and exhibit a stable electrode performance by covalently bonding an electron transfer mediator with a surface of a conductive base material constituting the electrode via a specific spacer, and a biofuel cell comprising the electron transfer mediator modified enzyme electrode. An electron transfer mediator modified enzyme electrode comprising a conductive base material connected to an external circuit, an oxidoreductase electron-transferable with the conductive base material and an electron transfer mediator which can mediate electron transfer between the conductive base material and the oxidoreductase, wherein the electron transfer mediator is covalently bonded to the surface of the conductive base material via a spacer containing at least a straight-chain structure, and a biofuel cell comprising the electron transfer mediator modified enzyme electrode.

### TECHNICAL FIELD

The present invention relates to an electron transfer mediator modified enzyme electrode comprising an electron transfer mediator, and a biofuel cell comprising the electron transfer mediator modified enzyme electrode.

### BACKGROUND ART

Enzymes are utilized for various analyses measuring abundance of material, for example, an enzyme sensor or the like due to its high substrate specificity. As the enzyme sensor utilizing enzyme, for example, there is a sensor which measures current produced by a redox reaction between a subject material of analysis (substrate) and an enzyme (oxidoreductase) and determinates quantity of the subject material. Specifically, a glucose sensor utilizes a proportion of current produced by a redox reaction between enzyme oxidizing glucose and glucose with respect to concentration of the glucose.

Further, currently, an enzyme is studied and developed as a novel catalyst for a fuel cell in place of a metallic catalyst such as platinum or the like. An enzymatic electrode utilizing current produced by a redox reaction between an enzyme and a substrate is expected to be utilized in a wide range of field besides the enzyme sensor and the fuel cell.

Generally, since the oxidoreductase is less likely to be directly subject to a redox reaction on the surface of an electrode formed of a conductive base material, efficiency of an electrode reaction is promoted by using an electron transfer mediator, which mediates electron transfer, between the oxidoreductase and the electrode. The electron transfer mediator transfers an electron received from an oxidoreductase which has oxidized a substrate to the electrode or transfers an electron received from the electrode to an oxidoreductase which reduces the substrate. A smooth electron transfer among “enzyme”-“electron transfer mediator”-“electrode” increases a current value of the enzymatic electrode and can obtain a biofuel cell which can produce sufficient current.

In the enzymatic electrode, the electron transfer mediator can be mixed or dispersed in an electrolyte or can be fixed on the surface of the electrode (conductive base material) in accordance with purpose of use, study or the like. In the case that the electron transfer mediator is dispersed in the electrolyte, a sufficient current density is less likely to be obtained since the dispersion of the electron transfer mediator controls rate in the electron transfer between “oxidoreductase”-“electron transfer mediator” and the electron transfer between “electron transfer mediator”-“electrode”. Hence, from the viewpoint of electrode performance, simplifying electrode constitution or the like, trend is toward fixing the electron transfer mediator on the surface of the electrode.

As a method of fixing the electron transfer mediator on the surface of the electrode (conductive base material), for example, there may be: (1) a method of fixing wherein an electron transfer mediator is solidified on a conductive base material with an organic polymer material and a pore formed by the organic polymer material holds the electron transfer mediator; (2) a method of fixing wherein a functional group of an organic polymer material or the like and a functional group of an electron transfer mediator are covalently bonded, and such an organic polymer material having the electron transfer mediator bonded is solidified on a conductive base material; (3) a method of fixing wherein an organic polymer material and an electron transfer mediator are covalently bonded using a crosslinking agent which forms a covalent bond between the organic polymer material and the electron transfer mediator, and such an organic polymer material having the electron transfer mediator bonded is solidified on a conductive base material; or the like.

Specifically, for example, Japanese Patent Application Laid-Open (JP-A) No. 2006-84183 discloses an enzymatic electrode obtained by coating a mixture of a specific polypyrrole based redox polymer having a metallic complex bonded and an oxidoreductase on an electrode which is a metallic layer coated on a protrusion formed on an end surface of an optical fiber to form a coating layer. JP-A No. 2006-84183 discloses, as a specific manufacture method of the enzymatic electrode, a method wherein an optical fiber electrode having the metallic layer formed on the protrusion on the end surface of the optical fiber is used as an electrode followed by electropolymerization in a mixture of a monomer constituting a redox polymer and an oxidoreductase.

### Problem to be Solved by the Invention

By fixing the electron transfer mediator on the conductive base material, which is the electrode, the current density obtainable from the enzymatic electrode improves. This is assumed because the electron transfer mediator and the conductive base material being an electrode are in close condition, an electron transfer rate between the electron transfer mediator and the electrode improves.

However, in the above-mentioned method of fixing the electron transfer mediator, the organic polymer material or the like for fixing the electron transfer mediator on the surface of the conductive base material is likely to detach in accordance with the decline of physical adsorptivity over time since such an organic polymer material is adsorbed to the surface of the conductive base material by weak physical adsorptivity. As the result, the condition in which the conductive base material being the electrode and the electron transfer mediator are close cannot be maintained, the improving effect of the electron transfer rate declines, and the current density decreases. That is, it is difficult to obtain a stable current for a long period by the above-mentioned conventional method of fixing the electron transfer mediator.

JP-A No. 2005-83873 discloses a biosensor comprising a liquid impermeable carbon base material and a bio-derived molecule or biomolecule on the carbon base material, wherein the bio-derived molecule or biomolecule is fixed via a reactive residue on the surface of the carbon base material and without a metallic layer or polymer layer. The technique of JP-A No. 2005-83873 is aimed to provision of the biosensor wherein the bio-derived molecule or biomolecule such as an enzyme, antibody, electron mediator, glycoprotein, cell, microorganism or the like is fixed to the carbon base material without the metallic layer or polymer layer. The bio-derived molecule or biomolecule is fixed to the carbon base material via a low-molecular weight linking molecule such as cyanuric chloride or the like, or directly by adsorption.

The biosensor of JP-A No. 2005-83873 does not particularly limit a structure or the like of the linking molecule (low-molecular weight) which fixes the bio-derived molecule or biomolecule to the carbon base material. Electron transferability of the linking molecule between “enzyme”-“electron transfer mediator” and electron transferability between “electron transfer mediator”-“electrode” when the electron transfer mediator is fixed to the carbon base material is not taken into account at all.

The present invention has been achieved in light of the above-stated conventional problems. An object of the present invention is to provide an electron transfer mediator modified enzyme electrode which can obtain a high current density and exhibit a stable electrode performance by covalently bonding an electron transfer mediator with a surface of a conductive base material constituting the electrode via a specific spacer, and a biofuel cell comprising the electron transfer mediator modified enzyme electrode.

### DISCLOSURE OF INVENTION

### Means for Solving the Problem

An electron transfer mediator modified enzyme electrode of the present invention comprises a conductive base material connected to an external circuit, an oxidoreductase electron-transferable with the conductive base material and an electron transfer mediator which can mediate electron transfer between the conductive base material and the oxidoreductase, wherein the electron transfer mediator is covalently bonded to the surface of the conductive base material via a spacer containing at least a straight-chain structure, and a biofuel cell comprising the electron transfer mediator modified enzyme electrode.

Since the electron transfer mediator modified enzyme electrode of the present invention (hereinafter, it may be simply referred to as a modification enzyme electrode) has the electron transfer mediator firmly fixed to the surface of the conductive base material being the electrode via the spacer by a covalent bond, a distance between the electrode and the electron transfer mediator can be kept constant for a long period. Therefore, the modification enzyme electrode of the present invention can exhibit a stable electrode property. Further, since the spacer which connects the conductive base material and the electron transfer mediator contains a straight-chain structure and is flexible, the electron transfer mediator fixed to the conductive base material via the spacer is highly flexible, and contact probabilities between the electron transfer mediator and respectively the conductive base material and the oxidoreductase are high. That is, the electron transfer rate between “conductive base material”-“electron transfer mediator” and between “oxidoreductase”-“electron transfer mediator” are high. Hence, according to the modification enzyme electrode of the present invention, high current density can be obtained.

As the electron transfer mediator, for example, an osmium (Os) complex can be exemplified.

When using an oxidoreductase oxidizing the substrate as the oxidoreductase, a substrate oxidizing enzyme electrode can be obtained as the modification enzyme electrode of the present invention.

From the viewpoint of flexibility of the electron transfer mediator fixed to the conductive base material, it is preferable that an end of the straight-chain structure of the spacer is covalently bonded to the surface of the conductive base material.

As the straight-chain structure of the spacer, one containing a linear carbon chain can be exemplified.

Kinds of covalent bond between the spacer and the conductive base material, the straight-chain structure of the spacer or the like may not be particularly limited. As a specific embodiment, for example, an embodiment wherein the straight-chain structure of the spacer is diamine, each end of which has an amino group, and the straight-chain structure of the spacer is covalently bonded to the surface of the conductive base material via an amino residue of one end of the diamine can be exemplified.

A chain length of the spacer is preferably at least 8 Å or more and a carbon number of the linear carbon chain of the spacer is preferably at least 2 or more since flexibility of the electron transfer mediator or accessibility (easiness of interaction) between the electron transfer mediator and the oxidoreductase can be increased, and electron transferabilities between the electron transfer mediator and the oxidoreductase and between the electron transfer mediator and the conductive base material (electrode) can be enhanced.

On the other hand, from the viewpoint of accessibility of the electron transfer mediator to the oxidoreductase, it is preferable that a straight-chain structure of the spacer which fixes (covalent bond) the electron transfer mediator to the surface of the conductive base material is adjusted in accordance with the oxidoreductase used in combination with the electron transfer mediator.

For example, if pyrroloquinoline quinone-dependent glucose dehydrogenase (PQQ-GDH) is used as the oxidoreductase, the chain length of the spacer is preferably 11 Å or more. Also, when the pyrroloquinoline quinone-dependent glucose dehydrogenase (PQQ-GDH) is used as the oxidoreductase, the carbon number of the linear carbon chain of the spacer is preferably 4 or more. Further, when the pyrroloquinoline quinone-dependent glucose dehydrogenase (PQQ-GDH) is used as the oxidoreductase, the carbon number of the linear carbon chain of the spacer is preferably 10 or less.

On the other hand, if flavin adenine dinucleotide-dependent glucose oxidase (FAD-GOD) is used as the oxidoreductase, the chain length of the spacer is preferably 11 Å or more. Also, when flavin adenine dinucleotide-dependent glucose oxidase (FAD-GOD) is used as the oxidoreductase, the carbon number of the linear carbon chain of the spacer is preferably 4 or more. Further, when flavin adenine dinucleotide-dependent glucose oxidase (FAD-GOD) is used as the oxidoreductase, the carbon number of the linear carbon chain of the spacer is preferably 10 or less.

According to a biofuel cell comprising the electron transfer mediator modified enzyme electrode of the present invention, a high current density can be obtained and a stable electric supply is capable for a long period.

### EFFECT OF THE INVENTION

According to the present invention, an excellent electron transfer mediator modified enzyme electrode exhibiting a high current density and a stable electrode performance can be obtained. Therefore, by using the enzymatic electrode of the present invention, a biofuel cell having a high electric performance and capable of supplying a stable electric power for a long period can be provided.

### BRIEF DESCRIPTION OF DRAWINGS

In the accompanying drawings,

FIG. 1 is a schematic diagram showing one embodiment of a biofuel cell comprising an electron transfer mediator modified enzyme electrode of the present invention;

FIG. 2 is an enlarged view of a surface of a conductive base material of one embodiment of an electron transfer mediator modified enzyme electrode of the present invention, and a schematic diagram showing of flexibility of an electron transfer mediator;

FIG. 3A is a schematic diagram showing an example of a three-dimensional structure of an oxidoreductase (PQQ-GDH);

FIG. 3B is a cross-sectional view of an example of an oxidoreductase (PQQ-GDH);

FIG. 4A is a view showing one example of a method to covalently bond an electron transfer mediator to a surface of a conductive base material;

FIG. 4B is a view showing one example of a method to covalently bond an electron transfer mediator to a surface of a conductive base material;

FIG. 5 is a graph showing dependency of stabilization amount on reaction time of amide condensation concerning electron transfer mediator to a surface of a conductive base material;

FIG. 6 is a graph showing the result of CV measurement of an enzymatic electrode in Example 1;

FIG. 7 is a graph showing a catalytic current value per stabilization amount of an electron transfer mediator to a conductive base material with respect to a carbon number “n” of a linear carbon chain in Examples 1 and 2; and

FIG. 8 is a graph showing the result of CV measurement of an enzymatic electrode in Example 2.

### BEST MODE FOR CARRYING OUT THE INVENTION

An electron transfer mediator modified enzyme electrode of the present invention comprises a conductive base material connected to an external circuit, an oxidoreductase electron-transferable with the conductive base material and an electron transfer mediator which can mediate electron transfer between the conductive base material and the oxidoreductase, wherein the electron transfer mediator is covalently bonded to the surface of the conductive base material via a spacer containing at least a straight-chain structure, and a biofuel cell comprising the electron transfer mediator modified enzyme electrode.

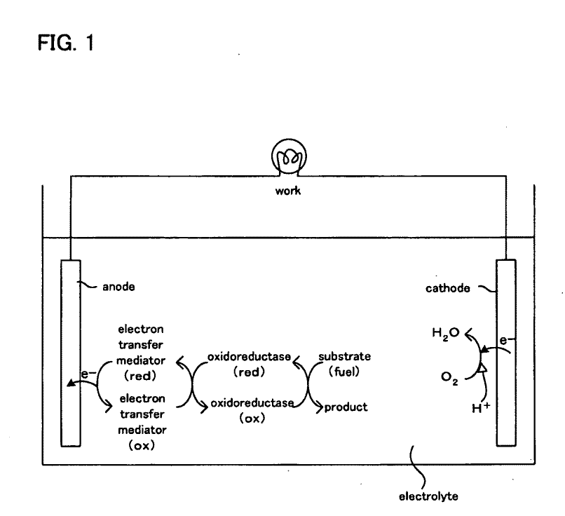

Hereinafter, with reference to FIG. 1, one embodiment of the biofuel cell comprising the electron transfer mediator modified enzyme electrode of the present invention (substrate oxidizing) will be explained.

Firstly, oxidase (or deoxidation enzyme) oxidizes a substrate such as glucose or the like, which is a fuel, to receive an electron. Next, the oxidase having received the electron transfers the electron to the electron transfer mediator, which mediates electron transfer between the oxidase and the electrode, and the electron is transferred to the conductive base material (anode) by the electron transfer mediator. Then, the electron reaches a cathode from the conductive base material being the anode through an external circuit to generate current.

The proton (H⁺) produced in the above process moves to the cathode through electrolyte. Then, at the cathode, the proton moved from the anode through the electrolyte, the electron moved from the anode side through the external circuit and an oxidant (cathode-side substrate) such as oxygen, hydrogen peroxide or the like react so as to produce water.

In such a fuel cell comprising the substrate oxidizing enzyme electrode, the obtainable current is dependent on the amount and rate of the electron transferred from the substrate to the electrode (conductive base material) via the oxidase and the electron transfer mediator, further, if necessary, an electron transfer medium such as other oxidase, electron transfer mediator or the like. That is, a redox reaction rate of each stage of the electron transfer system at the enzymatic electrode highly affects the current density of the enzymatic electrode. Hence, in order to obtain a high current, it is necessary to secure a smooth electron transfer by optimizing the positional relationship in the enzymatic electrode among the oxidoreductase, the electron transfer mediator and the conductive base material, the contact probability of each component and each member and so on.

In the present invention, the electron transfer mediator is not fixed to the surface of the electrode by using physical adsorption of a carrier such as an organic polymer material or the like, but the electron transfer mediator is connected to the surface of the conductive material being the electrode by a covalent bond so as to be fixed. The fixing by covalent bond is stronger and more stable with time than the fixing by the physical adsorption of the carrier. That is, according to the modification enzyme electrode of the present invention, it is possible to prevent the electron transfer mediator from detaching the electrode with time, and prevent decline of electric performance with time due to the electron transfer mediator detaching from the surface of the electrode.

Moreover, the modification enzyme electrode of the present invention fixes (covalent bond) the electron transfer mediator on the conductive base material via the spacer having a straight-chain structure. Since the spacer having a straight-chain structure is flexible and has a high kinetic degree of freedom, the contact probability between the electron transfer mediator fixed on the conductive base material via the spacer and the conductive base material is high and electron transfer between “electrode”-“electron transfer mediator” is efficient. Similarly, by fixing the electron transfer mediator to the surface of the conductive base material via the spacer having the high kinetic degree of freedom, the contact probability between the electron transfer mediator and the oxidoreductase increases, thus, the electron transfer between “electron transfer mediator”-“oxidoreductase” is efficient. Therefore, according to the modification enzyme electrode of the present invention, a high current density can be obtained.

Hereinafter, the modification enzyme electrode of the present invention will be explained in detail.

As the conductive base material constituting the electrode, there may not be particularly limited, but a general conductive base material can be used. For example, one made of conductive carbon such as graphite, carbon black, activated carbon or the like, or one made of metal such as gold, platinum or the like may be used. Specifically, there may be carbon paper, glassy carbon, HOPG (highly oriented pyrolytic graphite) or the like.

As the oxidoreductase oxidizing or reducing the substrate (fuel or oxidant), there may not be particularly limited, but may be appropriately selected according to the substrate to be used. For example, as the substrate oxidized enzyme, dehydrogenase, oxidase or the like may be used. Specifically, there may be glucosedehydrogenase (GDH), alcohol dehydrogenase (ADH), aldehyde dehydrogenase, glucoseoxidase (GOD), alcohol oxidase (AOD), aldehyde oxidase or the like. From the viewpoint of easily obtainable and manageable fuel and safety, GDH, ADH, GOD and AOD are preferably used. The oxidoreductase may be used alone or in combination of two or more kinds. Herein, a coenzyme and a prosthetic group of the oxidoreductase may not be particularly limited.

The oxidoreductase may be dispersed in the electrolyte together with the substrate if it can oxidize or reduce the substrate.

The electron transfer mediator may be appropriately selected according to the oxidoreductase to be used. For example, metal elements such as Os, Fe, Ru, Co, Cu, Ni, V, Mo, Cr, Mn, Pt, W or the like and metallic complexes having ion of these metals as a central metal; quinones such as quinone, benzoquinone, anthraquinone, naphthoquinone or the like; heterocyclic compounds such as viologen, methylviologen, benzylviologen or the like.

Among the above, since oxidoreduction potential can be adjusted by selection of ligand, the metallic complex is preferable, particularly osmium or the osmium complex having the osmium ion as the central metal (hereinafter, it may be referred to as “Os complex”) is preferable. As a specific example of the preferable Os complex, there may be osmium having two ligands coordinated represented by the following Formula (1):

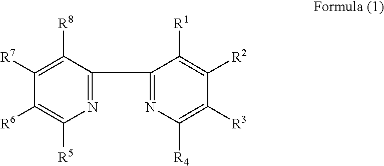

wherein, each of R₁ to R₈ is independently any of H, F, Cl, Br, I, NO₂, CN, COOH, SO₃H, NHNH₂, SH, OH, NH₂; or a substituted or non-substituted alkoxycarbonyl, alkylaminocarbonyl, dialkylaminocarbonyl, alkoxy, alkylamino, dialkylamino, alkanoylamino, arylcarboxyamide, hydrazino, alkylhydrazino, hydroxylamino, alkoxylamino, alkylthio, alkenyl, aryl or alkyl group.

A ligand other than two ligands in the above Formula (1) may be coordinated to the osmium complex. For example, a polymer having a coordinate portion may be coordinated to an osmium atom at the coordinate portion. Herein, the coordinate portion may be a part of a main chain of the polymer or a structure bonded in a pendant shape to the main chain via a chemical structure being a connecting group or directly to the main chain. For example, in poly(N-vinylimidazole) or poly(4-vinylpyridine), an imidazole group or a pyridine group respectively can function as one ligand, and coordinate to osmium being the central metal.

As other embodiment of the osmium complex fixed on the polymer, there may be an embodiment wherein a polymer is covalently bonded to a ligand of the Os complex. For example, there may be an embodiment wherein a reactive group of the ligand of the Os complex and a reactive group of the polymer react so as to form a covalent bond. Therein, the polymer and the ligand may be bonded via a chemical structure to be a spacer.

As the polymer having the Os complex fixed by the coordinate bond or covalent bond, any of a styrene/maleic anhydride copolymer, a methyl vinyl ether/maleic anhydride copolymer, a poly(4-vinylbenzylchloride) copolymer, a poly(allylamine) copolymer, a poly(4-vinylpyridine) copolymer, poly(4-vinylpyridine), poly(N-vinylimidazole) and poly(4-styrenesulfonate) is preferable. Among them, from the viewpoint of direct coordination to the Os complex, poly(N-vinylimidazole) and poly(4-vinylpyridine) are preferable.

Also, as other ligand of the osmium complex, for example, there may be at least one kind selected from Cl, F, Br, I, CN, CO, CH₃COO, NH₃, NO, pyridine and imidazole, but may not be limited and other kind which can create complex may be used. The ligand may be appropriately selected taking the oxidoreduction potential or the like of the obtainable Os complex into account.

The spacer covalently bonding the electron transfer mediator and the conductive base material has at least a straight-chain structure. Herein, the straight-chain structure is a chain structure not containing a cyclic structure (an aromatic ring and an aliphatic ring), may contain a branched structure, and may contain a bond other than a carbon atom-carbon atom bond such as a carbon atom-heteroatom bond, a heteroatom-heteroatom bond or the like. As a straight-chain structure containing heteroatom other than carbon, there may be specifically, for example, an ether bond, a thioether bond or the like.

The spacer may be solely a straight-chain structure, may have a ring structure at the end of bonding side with the conductive base material and/or at the end of bonding side with the electron transfer mediator, or may be a structure having a ring structure between the straight-chain structure and the straight-chain structure if the spacer has at least a straight-chain structure.

As a specific example of the straight-chain structure, there may be one containing a linear carbon chain. Herein, the linear carbon chain may have a branched structure or a side chain if the linear carbon chain has a continuous carbon atom structure in a straight chain form. However, an alkyl chain having no side chain or branched structure is preferable.

As the straight-chain structure the represented by the linear carbon chain, a structure not containing a highly rigid bond such as a double bond or the like is preferable from the viewpoint of kinetic degree of freedom due to its flexibility.

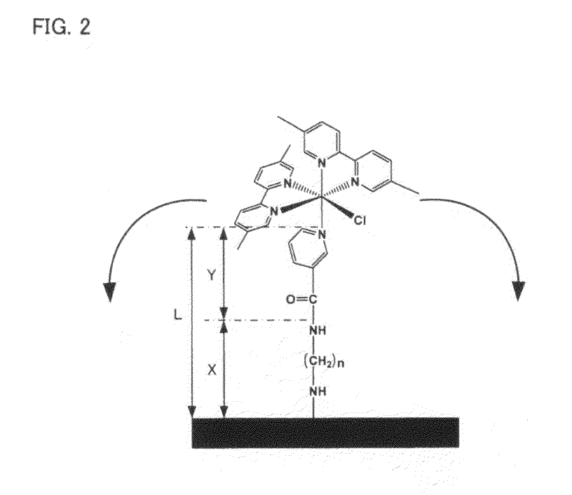

Since the kinetic degree of freedom is high and accessibility of the electron transfer mediator with each of the conductive base material and the oxidoreductase is high, the spacer which covalently bond with the conductive base material at the end of the straight-chain structure is preferable (see FIG. 2). In the case of having a bulky atom group such as a ring structure or the like at the end of the spacer directly bonded to the conductive base material, the kinetic degree of freedom of the spacer declines and accordingly mobility of the electron transfer mediator bonded to the other end of the spacer declines. As the result, the contact probabilities between the electron transfer mediator and the oxidoreductase and between the electron transfer mediator and the electrode decline, thus, a sufficient improving effect of electron transfer performance among “oxidoreductase”-“electron transfer mediator”-“electrode” is less likely to be obtained.

The functional group of the spacer forming the covalent bond with the conductive base material and the kind of reaction may not be particularly limited. For example, there may be a covalent bond of an amino residue (an amino group which has lost a hydrogen atom) utilizing oxidation of an amino group, and mercaptide having a hydrogen atom of mercaptan substituted by a metal atom “M”.

The spacer is covalently bonded at one end thereof with the surface of the conductive base material, and bonded at the other end with the electron transfer mediator. The kind of bond between the spacer and the electron transfer mediator may not be particularly limited. For example, in the case of using a metallic complex as the electron transfer mediator, the end of the spacer may be coordinately bonded to the central metal of the metallic complex being the electron transfer mediator, or the spacer may be covalently bonded to the ligand coordinated to the central metal of the metallic complex.

From the viewpoint of flexibility (mobility) of the electron transfer mediator, it is preferable that the chain length of the spacer which fixes (covalent bond) the electron transfer mediator to the surface of the conductive base material is at least 8 Å or more. Also, the carbon number of the linear carbon chain in the spacer is preferably at least 2 or more.

Herein, the chain length (L) of the spacer is a length of the spacer connecting the surface of the conductive base material and the electron transfer mediator. Specifically, for example, in the case of using a metallic complex shown in FIG. 2 as the electron transfer mediator, the chain length (L) is a length from the surface of the conductive base material to the end of the spacer coordinated to the central metal of the metallic complex. In FIG. 2, the chain length (L) is the length (X+Y) of diamine (X) covalently bonded to the surface of the conductive base material and nicotine acid (Y). Also, the carbon number of the linear carbon chain is “n” in FIG. 2.

If the chain length of the spacer which determinates the flexibility of the electron transfer mediator, particularly the chain length of the straight-chain structure, is too short, the flexibility of the electron transfer mediator is not sufficient, thus, the contact probability of the electron transfer mediator with each of the oxidoreductase and the conductive base material cannot be improved. That is, the electron transfer among “oxidoreductase”-“electron transfer mediator”-“conductive base material (electrode)” is not smooth.

On the other hand, from the viewpoint of accessibility of the electron transfer mediator to the oxidoreductase, the straight-chain structure of the spacer which fixes (covalent bond) the electron transfer mediator to the surface of the conductive base material is preferably adjusted according to the oxidoreductase used in combination with the electron transfer mediator.

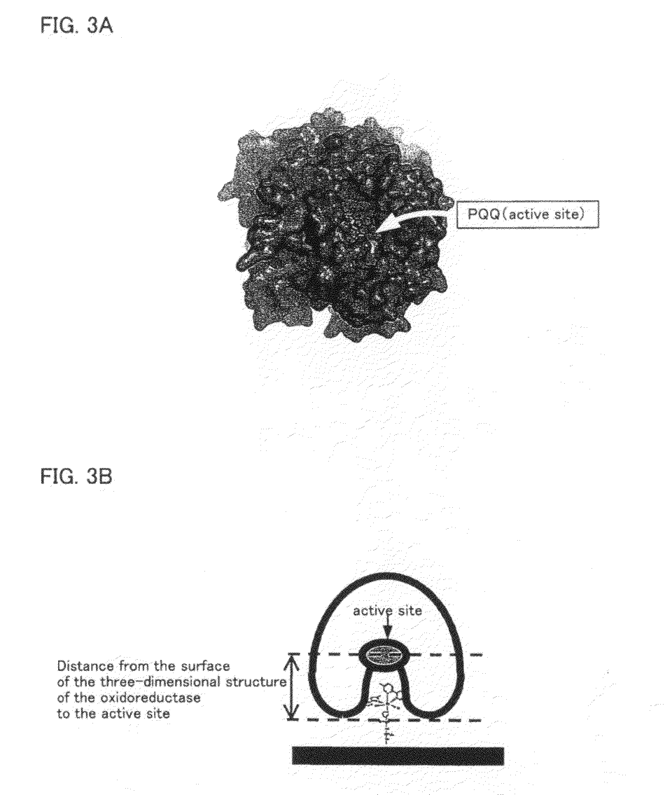

Generally, the oxidoreductase has its active site at apart on the inward side of a surface of the three-dimensional structure of the oxidoreductase as shown in FIG. 3. That is, the electron transfer mediator reaches the active site which is on the inward side of the oxidoreductase so as to transfer the electron from the oxidoreductase to the electron transfer mediator. The location of the active site from the surface of the three-dimensional structure of the oxidoreductase varies from the kind of oxidoreductase.

The inventors of the present invention has found out that by adjusting and optimizing the chain length of the straight-chain structure in the spacer which fixes the electron transfer mediator to the conductive base material in accordance with the oxidoreductase to be used, the accessibility of the electron transfer mediator to the active site of the oxidoreductase improves, and the electron transfer between the electron transfer mediator and the oxidoreductase can be smooth.

Typically, if the chain length of the spacer is not longer than the distance from the surface of the three-dimensional structure of the oxidoreductase to the active site, the electron transfer between the oxidoreductase and the electron transfer mediator cannot be smooth. On the other hand, it is assumed that if the electron transfer mediator is bonded to the surface of the conductive base material using an excessively long spacer, the rigidity of the spacer decreases too much so as to decrease the rate of mobility, thus, the electron transferabilities between the electron transfer mediator and the oxidoreductase and between the electron transfer mediator and the base material decline.

For example, if pyrroloquinoline quinone-dependent glucose dehydrogenase (GDH having PQQ as a prosthetic group; PQQ-GDH) is used as the oxidoreductase, it is preferable that the chain length of the spacer is 8 Å or more, particularly 11 Å or more. Also, when PQQ-GDH is used as the oxidoreductase, in the case of containing the linear carbon chain in the straight-chain structure of the spacer, it is preferable that the carbon number of the linear carbon chain is 2 or more, particularly 4 or more. On the other hand, it is preferable that the carbon number of the linear carbon chain is preferably 12 or less, particularly 10 or less.

Also, when flavin adenine dinucleotide-dependent glucose oxidase (GOD having FAD as a coenzyme; FAD-GOD) is used as the oxidoreductase, it is preferable that the chain length of the spacer is 8 Å or more, particularly 11 Å or more. Also, when FAD-GOD is used as the oxidoreductase, in the case of containing the linear carbon chain in the straight-chain structure of the spacer, it is preferable that the carbon number of the linear carbon chain is 2 or more, particularly 4 or more. On the other hand, the carbon number of the linear carbon chain is preferably 12 or less, particularly 10 or less.

A method of covalently bonding the electron transfer mediator to the surface of the conductive base material via the spacer may not be particularly limited. Hereinafter, the following two methods will be explained specifically.

A first method is to covalently bond the spacer to the surface of the conductive base material, and then to chemically bond the end of the spacer other than one covalently bonded to the surface of the conductive base material with the electron transfer mediator. As a specific example of the first method, a case using a conductive base material made of a conductive carbon (hereinafter, it may be referred to as a carbon base material), diamine having a straight-chain alkylene group, each end of which has an amino group, as a spacer precursor, and an Os complex having a ligand which has an acid group capable of an amide condensation with an amino group such as nicotine acid coordinated as the electron transfer mediator will be hereinafter explained.

Firstly, in the condition that a carbon base material is dipped in electrolyte containing diamine having the straight-chain alkylene group, each end of which has an amino group (hereinafter, it may be simply referred to as diamine), the electric potential of the carbon base material is swept to change in a predetermined range. Thereby, the diamine in the electrolyte is electrolytically oxidized, hydrogen detaches from one amino group, and the diamine is covalently bonded to the surface of the carbon base material via the amino residue.

Next, the other amino group of the above diamine covalently bonded to the surface of the carbon base material via the amino residue is bonded to an acid group of a ligand of an Os complex by an amide condensation. If necessary, catalyst may be used upon the amide condensation reaction. More specific method will be explained in Example.

A second method is to prepare an electron transfer mediator having a spacer covalently bonded, and to covalently bond the other end of the spacer chemically bonded to the electron transfer mediator to a surface of a conductive base material. As a specific example of the second method, a case using an Os complex in which a compound having an amino group at one end of the straight-chain alkylene group and having a coordinate portion capable of coordinating with Os such as an imidazole ring at the other end is coordinated to Os at the above imidazole ring (coordinate portion) as the electron transfer mediator, and the carbon base material as the conductive base material will be hereinafter explained.

Firstly, the Os complex in which the above-mentioned compound having the amino group and the imidazole ring (spacer) is coordinated to Os at the imidazole ring (coordinate portion) is prepared. Next, in the condition that the carbon base material is dipped in electrolyte containing the above-mentioned Os complex, the electric potential of the carbon base material is swept to change in a predetermined range. Thereby, the amino group at the end of the spacer coordinated to the Os complex is electrolytically oxidized, hydrogen detaches, and the Os complex is covalently bonded to the surface of the carbon base material via the amino residue.

A method of adjusting the chain length of the straight-chain structure in the spacer may not be particularly limited. For example, in the first method, diamine containing a straight-chain alkylene group having a desired chain length may be used as the diamine. That is, the diamine containing the straight-chain alkylene group having a desired chain length is solved or dispersed in electrolyte, and the electric potential of the carbon base material dipped in the electrolyte is swept to change, thereby the electron transfer mediator can be covalently bonded to the surface of the carbon base material via the spacer having the straight-chain structure of a desired chain length.

In the second method, a compound containing the straight-chain alkylene group having a desired chain length may be used as the compound which coordinates to Os by the imidazole ring (coordinate portion). That is, by coordinating the compound having the amino group and the coordinate portion at the end of the straight-chain alkylene group having a desired chain length to the Os complex, the electron transfer mediator can be covalently bonded to the surface of the carbon base material via the spacer having the straight-chain structure of a desired chain length.

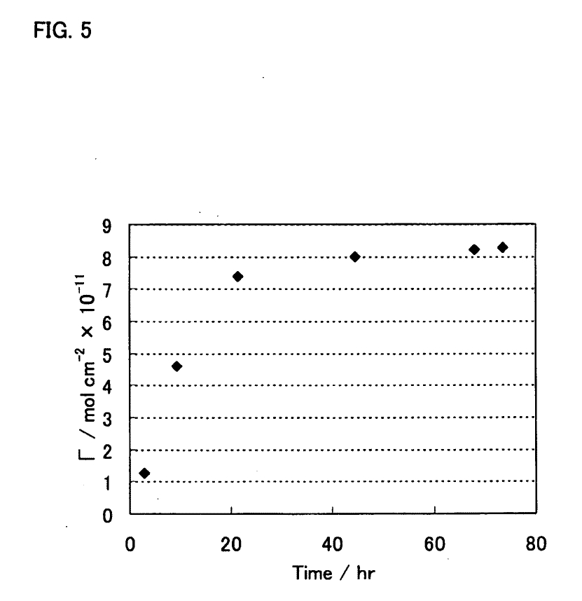

A stabilization amount of the electron transfer mediator to the surface of the conductive base material by covalent bond depends on the reaction time of the covalent bond (see FIG. 5). Thus, by controlling the stabilization amount, an amount of the electron transfer mediator which fixes to the surface of the conductive base material by the covalent bond can be adjusted. The reaction time of the covalent bond varies depending on the covalent bonding method of the electron transfer mediator to the surface of the conductive base material via the spacer. For example, a reaction time in the first method is time of amide condensation between the amino group of the diamine covalently bonded to the surface of the carbon base material (base material) and the acid group of the ligand in the Os complex. Herein, an amount of the diamine covalently bonded to the surface of the carbon base material is considered to be the maximum amount (saturated amount).

In the second method, by controlling the reaction time of the electrolytic oxidation of the amino group at the end of the spacer coordinated to the Os complex, the stabilization amount of the Os complex being the electron transfer mediator to the conductive base material can be controlled.

The maximum amount (maximum stabilization amount) of the electron transfer mediator which can be fixed to the surface of the conductive base material by covalent bond varies depending on the conductive base material to be used, the electron transfer mediator and the spacer to be covalently bonded or the like. For example, in the case of the electron transfer mediator (Os complex), the spacer (straight-chain alkyldiamine) and the conductive base material (carbon base material) used in Example, the maximum stabilization amount is about 8×10⁻¹¹ mol/cm² as shown in FIG. 5.

In order to efficiently and steadily proceed a redox reaction of the oxidoreductase and the electron transfer mediator, which is an electrode reaction, it is preferable that pH of the electrolyte is maintained at an optimal pH value, for example, around pH 7. For adjustment of pH, for example, a buffer such as a tris buffer, a phosphate buffer, morpholinopropanesulfonic acid (MOPS) or the like may be used.

Also, in order to efficiently and steadily proceed with the redox reaction being the electrode reaction, the oxidoreductase and the electron transfer mediator are preferably maintained, for example, at about 20 to 30° C.

As the substrate of the oxidoreductase, biological nutrient source can be widely utilized. For example, there may be carbohydrate or a ferment product thereof. Particularly, alcohol, sugar and aldehyde may be preferably used. Specifically, there may be alcohol such as methanol, ethanol, propanol, glycerin, polyvinyl alcohol or the like; sugar group such as glucose, fructose, sorbose or the like; aldehyde such as formaldehyde, acetic aldehyde or the like. Also, there may be used an organic acid such as an intermediate product of sugar metabolism or the like including fat, protein or the like, or mixture thereof.

In the case of using the enzymatic electrode of the present invention as an electrode for a fuel cell, particularly glucose or alcohol is suitably used from the viewpoint of great easiness in handling, availability, small effect on environment and so on.

As the cathode paired with the anode consisting of the substrate oxidizing enzyme electrode, for example, a conductive body made of a carbon material including graphite, carbon black, activated carbon etc., gold, platinum or the like carrying an electrode catalyst generally used for a fuel cell such as a catalyst effective with reducing reaction of an oxidant including platinum, platinum alloy or the like, or a conductive body which is electrode catalyst itself such as platinum, platinum alloy or the like may be used. In the embodiment, the oxidant is supplied to the electrode catalyst.

Alternatively, the cathode paired with the anode consisting of the substrate oxidizing enzyme electrode may be a substrate reducing enzymatic electrode. As an oxidoreductase reducing the oxidant, there may a well-known oxidoreductase such as laccase, bilirubin oxidase or the like. In the case of using the oxidoreductase as the catalyst reducing oxidant, if necessary, a well-known electron transfer mediator may be used. As the oxidant, there may be oxygen, hydrogen peroxide or the like.

In order to avoid effect of impurities preventing the electrode reaction at the cathode, for example, ascorbic acid, uric acid or the like, an oxygen-selective layer such as dimethylpolysiloxane or the like may be arranged around the cathode.

Since the electron transfer mediator modified enzyme electrode of the present invention can obtain a stable electrode performance and a high current density, by using the electrode for an electrode for a biofuel cell, a biofuel cell which is capable of a stable electric supply for a long period and excellent in electric performance can be provided.

Also, the modification enzyme electrode of the present invention can be used for, besides the biofuel cell, an enzyme sensor, an enzyme transistor or the like. When the enzymatic electrode of the present invention is used for the enzyme sensor, presence or density of substrate can be measured by detecting current or voltage generated in development of the redox reaction between the enzyme and the substrate. According to the modification enzyme electrode of the present invention, a high current density can be obtained, thus, an enzyme sensor having high sensitivity and capable of maintaining a stable accuracy for a long time can be provided.

### EXAMPLES

### Production of Enzymatic Electrode

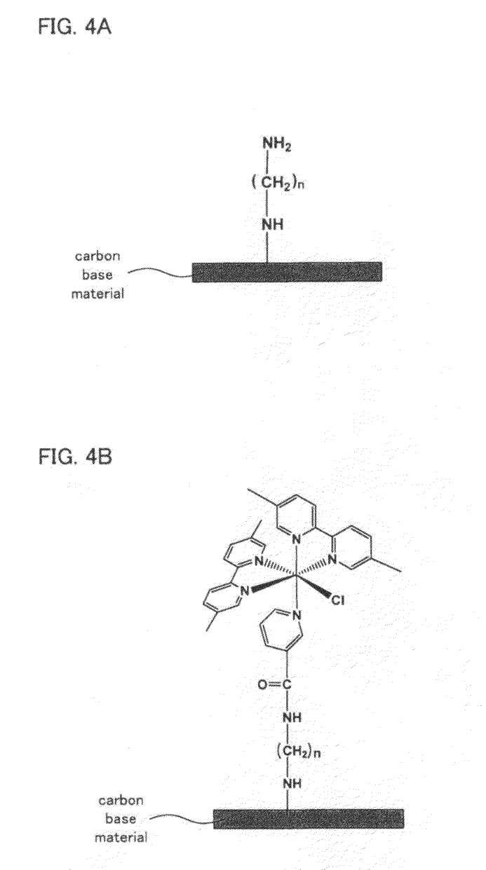

A carbon base material (glassy carbon of 3 mmφ) was dipped in a buffered aqueous solution of diamine [NH₂— (CH₂)ₙ—NH₂] (KH₂PO₃ of 10 mM; pH 12.5; Iₛ (ionic strength) of 0.1; diamine concentration of 10 mM). An electric potential of the carbon base material was changed in the range of −0.2 to 0.5 V (vs.Ag/AgCl) for about 20 times at a sweeping rate of 50 mV/s so as to covalently bond diamine to the surface of the carbon base material by an electrolytic oxidation of amino group (see FIG. 4A).

Separately, an Os complex coordinating six chlorine atoms (OsCl₆) was prepared and reacted with OsCl₆ and 5,5′-dimethyl-2,2′-bipyridine at 200° C. for two hours. Then, dithiophosphite was added to react for 30 minutes on ice, four chlorine atoms coordinated to Os were substituted by two of 5,5′-dimethyl-2,2′-bipyridine having two ligands. Next, nicotine acid was added to react at 200° C. for two hours. Further, NH₄PF₆ was added to react, thereby, one chlorine atom coordinated to Os was substituted by the nicotine acid. Thus, Os(5,5′-dimethyl-2,2′-bipyridyldine)₂Cl(nicotine acid) (hereinafter, it is referred to as Os complex I) was synthesized (see Formula (2)).

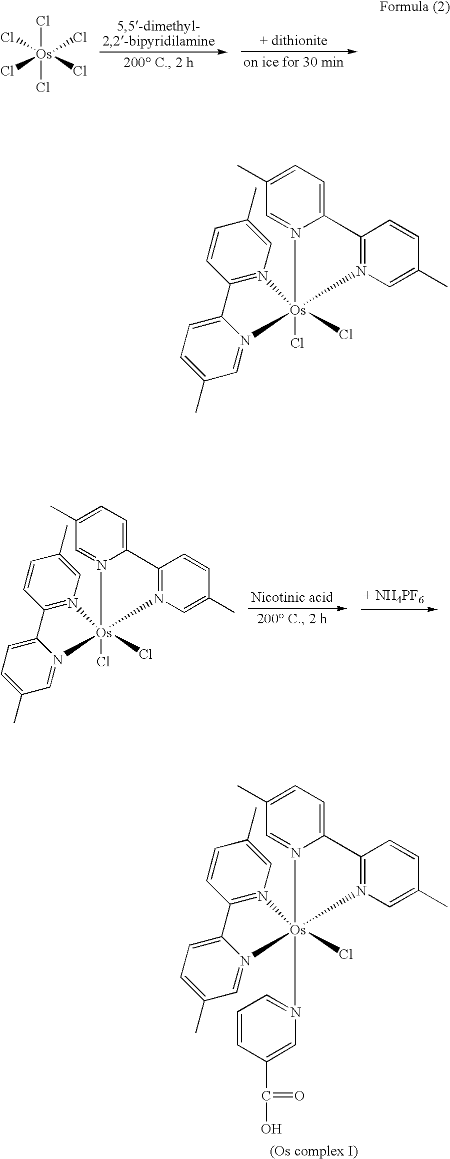

The above-mentioned carbon base material having the diamine covalently bonded (see FIG. 4A) was dipped in a liquid in which 0.1 M of phosphate buffer (pH7) and 20 mM of Os complex I in dimethylsulfoxide (DMSO) liquid are mixed at 9:1 (volume ratio) (Os complex concentration of 2 mM). In the presence of a catalyst represented by the following Formula (3), the amino group of the diamine on the carbon base material and the nicotine acid of the Os complex I were subject to amide condensation so as to covalently bond the Os complex I on the surface of the carbon base material via the diamine (see FIG. 4B).

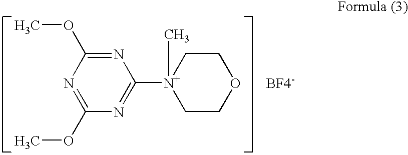

FIG. 5 is a graph showing dependency of the stabilization amount of the Os complex covalently bonded to the surface of the carbon base material via the diamine on the amide condensation reaction time upon performing the amide condensation with the amino group of the diamine on the carbon base material and the nicotine acid of the Os complex I so as to covalently bond the Os complex I to the surface of the carbon base material via the diamine similarly as Example 1 mentioned below. From FIG. 5, it can be understood that the amount of Os complex (electron transfer mediator) fixed to the surface of the carbon base material can be adjusted by controlling the reaction time of the amide condensation. In FIG. 5, when the amide condensation reaction time reaches about 50 hours, the stabilization amount of the Os complex reaches almost saturation (maximum stabilization amount: about 8×10⁻¹¹ mol/cm²).

### Example 1

According to the above-mentioned production of enzymatic electrode, Enzymatic electrodes 1 to 6 were produced using diamine different in the straight-chain carbon number “n”. In each enzymatic electrode, the carbon number “n” of the linear carbon chain in diamine, the chain length L of the spacer and the stabilization amount of the Os complex per unit area are as shown in Table 1.

TABLE 1

| | | | Stabilization |
|---|---|---|---|
| | Carbon | Chain | amount of Os |
| | number “n” | length L of | complex |
| | of diamine | spacer (Å) | (mol/cm²) |
| Enzymatic | 2 | 8 | 2.06 × 10⁻¹¹ |
| electrode 1 | | | |
| Enzymatic | 4 | 11 | 2.555 × 10⁻¹¹ |
| electrode 2 | | | |
| Enzymatic | 6 | 13 | 4.8 × 10⁻¹¹ |
| electrode 3 | | | |
| Enzymatic | 8 | 16 | 2.94 × 10⁻¹¹ |
| electrode 4 | | | |
| Enzymatic | 10 | 19 | 3.66 × 10⁻¹¹ |
| electrode 5 | | | |
| Enzymatic | 12 | 22 | 6.995 × 10⁻¹¹ |
| electrode 6 | | | |

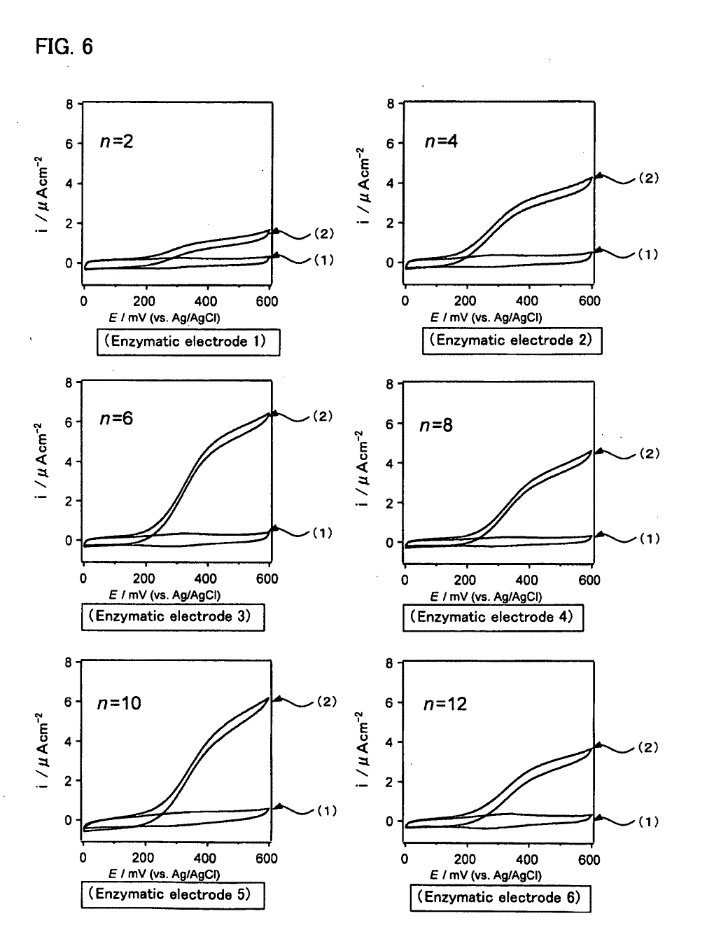

Each enzymatic electrode obtained was subject to the cyclic voltammetry (CV) under the conditions (1) and (2) mentioned below. The results are shown in FIG. 6. The CV under the condition (2) was performed for ten times until the catalytic current value became stable. The maximum current value is shown in FIG. 6.

### <Condition of CV>

Cell volume: 1 mL
Scan rate: 20 mV/s
Electrolyte: (1) 100 mM of phosphate buffer (pH 7) alone (2) 100 mM of phosphate buffer (pH 7), glucose of 100 mM and PQQ-GDH of 0.04 mg

FIG. 6 shows that, from each CV curve (1) of the above-mentioned condition (1), the Os complex is fixed to the glassy carbon of each enzymatic electrode. Also, it can be understood from the CV curve (2) under the above-mentioned condition (2) in FIG. 6 that the Os complex fixed to the surface of the glassy carbon of each enzymatic electrode functions as the electron transfer mediator in the electrolyte containing the oxidoreductase (PQQ-GDH) and the substrate (glucose).

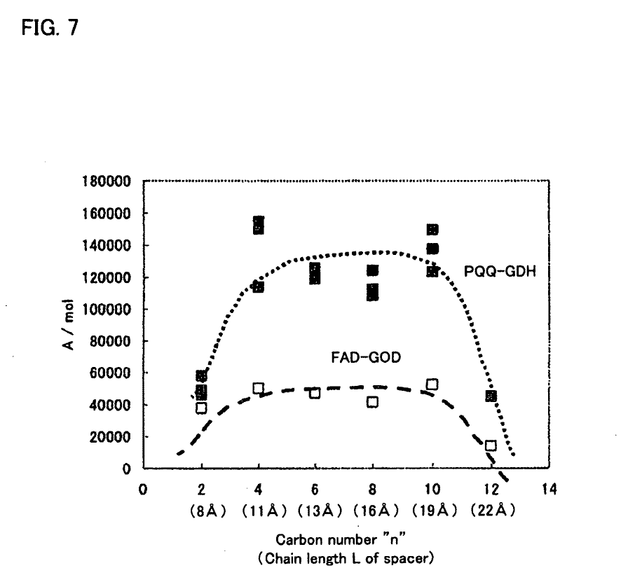

Additionally, a catalytic current per stabilization amount of the Os complex for each enzymatic electrode was obtained by calculating the catalytic current value of each enzymatic electrode from the difference between the oxidation current value of the Os complex calculated from the CV under the condition (1) and the maximum oxidation current value of glucose calculated from CV under the condition (2), and dividing the catalytic current value with the amount of Os complex fixed to the glassy carbon. The results are shown in FIG. 7. In FIG. 7, data of each enzymatic electrode 1 to 6 having different stabilization amount of the Os complex are also shown.

### Example 2

In the above-mentioned production of enzymatic electrode, Enzymatic electrodes 7 to 12 are produced using diamine different in the straight-chain carbon number “n”. The carbon number “n” of the linear carbon chain in diamine, the chain length L of the spacer and the stabilization amount of the Os complex per unit area in each enzymatic electrode are shown in Table 2.

TABLE 2

| | | | Stabilization |
|---|---|---|---|
| | Carbon | Chain | amount of Os |
| | number “n” | length L of | complex |
| | of diamine | spacer (Å) | (mol/cm²) |
| Enzymatic | 2 | 8 | 2.2 × 10⁻¹¹ |
| electrode 7 | | | |
| Enzymatic | 4 | 11 | 2.555 × 10⁻¹¹ |
| electrode 8 | | | |
| Enzymatic | 6 | 13 | 4.8 × 10⁻¹¹ |
| electrode 9 | | | |
| Enzymatic | 8 | 16 | 2.94 × 10⁻¹¹ |
| electrode 10 | | | |
| Enzymatic | 10 | 19 | 3.8 × 10⁻¹¹ |
| electrode 11 | | | |
| Enzymatic | 12 | 22 | 6.5 × 10⁻¹¹ |
| electrode 12 | | | |

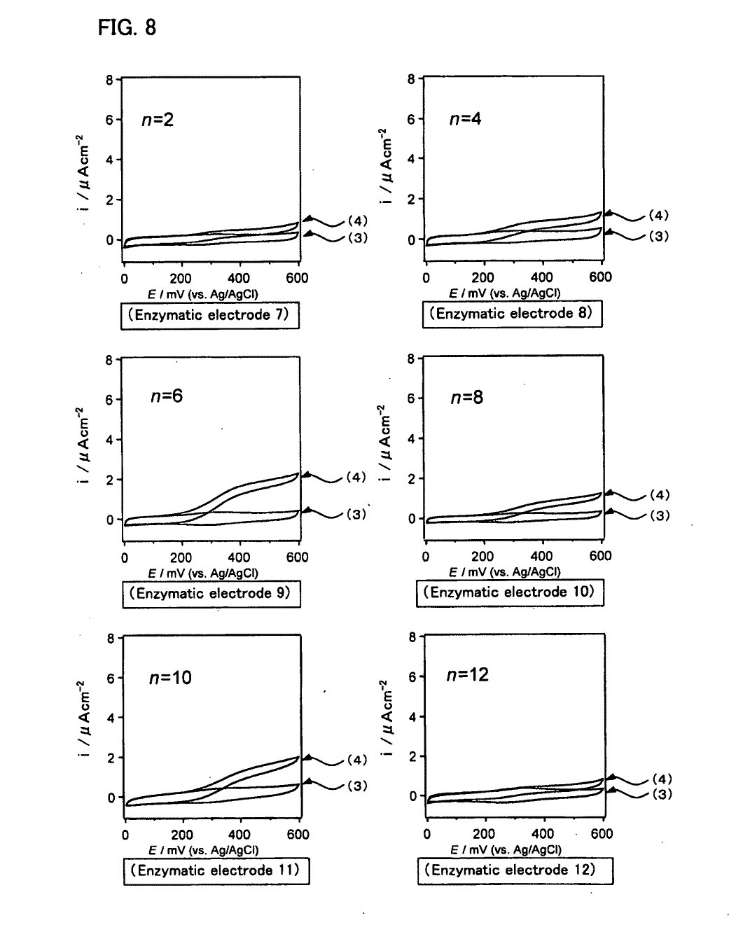

Each enzymatic electrode obtained was subject to the cyclic voltammetry (CV) under the conditions (3) and (4) mentioned below. The results are shown in FIG. 8. The CV under the condition (4) was performed for three times until the catalytic current value became stable. The maximum current value is shown in FIG. 8.

### <Condition of CV>

Cell volume: 1 mL
Scan rate: 20 mV/s
Electrolyte: (3) 100 mM of phosphate buffer (pH 7) alone (4) 100 mM of phosphate buffer (pH7), glucose of 100 mM and FAD-GOD of 0.04 mg

FIG. 8 shows that, from each CV curve (3) of the above-mentioned condition (3), the Os complex is fixed to the glassy carbon of each enzymatic electrode. Also, it can be understood that, from the CV curve (4) under the above-mentioned condition (4) in FIG. 8, the Os complex fixed to the surface of the glassy carbon of each enzymatic electrode functions as the electron transfer mediator in the electrolyte containing the oxidoreductase (FAD-GOD) and the substrate (glucose).

Additionally, the catalytic current per stabilization amount of the Os complex for each enzymatic electrode was calculated by calculating the catalytic current value of each enzymatic electrode from the difference between the oxidation current value of the Os complex calculated from the CV under the condition (3) and the maximum oxidation current value of glucose calculated from the CV under the condition (4), and dividing the catalytic current value with the amount of Os complex fixed to the glassy carbon. The results are shown in FIG. 7.

FIG. 7 shows that a high catalytic current value can be obtained by using the spacer having the carbon number “n” of the linear carbon chain of 4 to 10 and having the chain length L of spacer of 11 to 19 Å when PQQ-GDH is used as the enzyme. It can be considered that when the diamine is n=2, the spacer is so short that the mobility and accessibility of the Os complex decline and the electron transferabilities between the Os complex being the electron transfer mediator and the oxidoreductase and between the Os complex and the conductive base material decrease. As the result, the catalytic current value became small. On the other hand, when the diamine is n=12, the spacer is so long that the rigidity of the spacer declines excessively causing decrease in mobility rate and the electron transferabilities between the electron transfer mediator and the oxidoreductase and between the electron transfer mediator and the conductive base material decrease. As the result, the catalytic current value became small.

Also, in the case of using FAD-GOD as the enzyme, FIG. 7 shows that a high catalytic current value can be obtained by using the spacer having the carbon number “n” of the linear carbon chain of 4 to 10 and the chain length L of spacer of 11 to 19 Å. Similarly as using the PQQ-GDH, it can be considered that in the case of diamine of n=2, since the spacer is so short that the mobility and accessibility of the Os complex decrease, and the electron transferabilities between the Os complex being the electron transfer mediator and the oxidoreductase and between the Os complex and the conductive base material decrease, hence, the catalytic current value became small. On the other hand, in the case of diamine of n=12, since the spacer is so long that the rigidity of the spacer excessively decreases causing decrease in mobility rate, and the electron transferabilities between the electron transfer mediator and the oxidoreductase and between the electron transfer mediator and the conductive base material decrease. As the result, the catalytic current value became small.

1. An electron transfer mediator modified enzyme electrode comprising a conductive base material connected to an external circuit, an oxidoreductase electron-transferable with the conductive base material and an electron transfer mediator which can mediate electron transfer between the conductive base material and the oxidoreductase,
wherein the conductive base material is made of conductive carbon; and
wherein the electron transfer mediator is covalently bonded on the surface of the conductive base material via a spacer containing at least a straight-chain structure, and the straight-chain structure of the spacer is diamine, each end of which has an amino group, and the straight-chain structure of the spacer is covalently bonded to the surface of the conductive base material via an amino residue of one end of the diamine.

2. An electron transfer mediator modified enzyme electrode according to claim 1, wherein the electron transfer mediator is an osmium complex.

3. An electron transfer mediator modified enzyme electrode according to claim 1, wherein the electron transfer mediator modified enzyme electrode is a substrate oxidizing enzyme electrode.

4. An electron transfer mediator modified enzyme electrode according to claim 1, wherein an end of the straight-chain structure of the spacer is covalently bonded to the surface of the conductive base material.

5. An electron transfer mediator modified enzyme electrode according to claim 1, wherein the straight-chain structure of the spacer contains a linear carbon chain.

6. (canceled)

7. An electron transfer mediator modified enzyme electrode according to claim 1, wherein a chain length of the spacer is at least 8 Å or more.

8. An electron transfer mediator modified enzyme electrode according to claim 5, wherein a carbon number of the linear carbon chain of the spacer is at least 2 or more.

9. An electron transfer mediator modified enzyme electrode according to claim 1, wherein the electron transfer mediator modified enzyme electrode includes pyrroloquinoline quinone-dependent glucose dehydrogenase (PQQ-GDH) as the oxidoreductase, and a chain length of the spacer is 11 Å or more.

10. An electron transfer mediator modified enzyme electrode according to claim 5, wherein the electron transfer mediator modified enzyme electrode includes pyrroloquinoline quinone-dependent glucose dehydrogenase (PQQ-GDH) as the oxidoreductase, and a carbon number of the linear carbon chain of the spacer is 4 or more.

11. An electron transfer mediator modified enzyme electrode according to claim 5, wherein the electron transfer mediator modified enzyme electrode includes pyrroloquinoline quinone-dependent glucose dehydrogenase (PQQ-GDH) as the oxidoreductase, and a carbon number of the linear carbon chain of the spacer is 10 or less.

12. An electron transfer mediator modified enzyme electrode according to claim 1, wherein the electron transfer mediator modified enzyme electrode includes flavin adenine dinucleotide-dependent glucose oxidase(FAD-GOD) as the oxidoreductase, and a chain length of the spacer is 11 Å or more.

13. An electron transfer mediator modified enzyme electrode according to claim 5, wherein the electron transfer mediator modified enzyme electrode includes flavin adenine dinucleotide-dependent glucose oxidase(FAD-GOD) as the oxidoreductase, and a carbon number of the linear carbon chain of the spacer is 4 or more.

14. An electron transfer mediator modified enzyme electrode according to claim 5, wherein the electron transfer mediator modified enzyme electrode includes flavin adenine dinucleotide-dependent glucose oxidase(FAD-GOD) as the oxidoreductase, and a carbon number of the linear carbon chain of the spacer is 10 or less.

15. A biofuel cell comprising an electron transfer mediator modified enzyme electrode defined by claim 1.
